(19) United States
(12) Patent Application Publication
(10) Pub. No.: US 2016/0199841 A1
(43) Pub. Date: Jul. 14, 2016

(54) CERAMIC MATERIAL GRANULATOR

(71) Applicant: Kwok Fai Edmund SO, Hong Kong (HK)

(72) Inventor: Kwok Fai Edmund SO, Hong Kong (HK)

(21) Appl. No.: 14/595,159

(22) Filed: Jan. 12, 2015

(51) Int. Cl. B02C 4/32; B02C 4/02

(52) U.S. Cl. CPC B02C 4/32; B02C 4/02

(57) ABSTRACT

According to the embodiments of the disclosed technology, systems, methods and devices are provided for pelletizing ceramic material. In one embodiment, a device is provided that has a frame, a movable housing, a first rotating unit, and a second rotating unit. The moving housing is configured such that detection of a slower movement of the ceramic raw material flow through holes of the first rotating unit and the second rotating unit causes the movable housing to be actuated to move the second rotating unit further away from the first rotating unit. The movement is carried out through the actuator coupled relative to the frame, in order to create more space movement between the first and second rotating units.

### FIELD OF THE INVENTION

This invention relates to pelletizing ceramic material. Specifically, the present invention relates to pelletizing ceramic material into granular ceramic particles of certain shapes and styles.

### BACKGROUND OF THE INVENTION

With the development of the construction industry, the demand for ceramic material has been increasing substantially. In order to facilitate transportation of ceramic material, construction workers refine raw ceramic material into smaller sizes so that the raw material can be further processed for other manufacturing uses at a later time. In the refining stages, however, manual processes are involved and lack consistency in refining particles to certain sizes and shapes.

Sometimes however, the processed particles may form layers with cracks. As a result, further refining or processing work is needed by the customers even after the raw material is transported to the destination. Additionally, raw ceramic material before and during transportation is often is left exposed in an open environment that would make the material very easy to form clumps. Accordingly, specific solutions are desired from the industry when it comes to managing granulized raw ceramic material.

In view of the foregoing, there is a need for an apparatus, system and method for carrying out the improved pelletizing of ceramic raw material and facilitating the transport and management of finished material.

### SUMMARY OF THE INVENTION

According to the embodiments of the invention, systems, machines, devices are provided for effective pelletizing ceramic raw material. In one embodiment, a device is provided that includes a frame, a movable housing, a first rotating unit, a second rotating unit, an object with an opening located on top of the first rotating unit and the second rotating unit, and a logical processor. The movable housing is movably attached to the frame (1) through an actuator (9) coupled relative to the frame.

Two or more rotating units may be attached to the frame. In one embodiment, a first rotating unit may be rotatably coupled to a power source (6) through a rotatable body (4). The second rotating unit (2) may be rotatably coupled to a power housing structure (8) through a similar powering mechanism (7). In both rotating units, holes (11) are included in the rotating unit. The second rotating unit (2). The second rotating unit (3) is separated from the first rotating unit (2) relative to the frame (1). The embodied device may contain an object that has at least one opening located on top of the first rotating unit and the second rotating unit, allowing the ceramic raw material to be received into the first rotating unit and the second rotating unit.

The logical processor includes a detection mechanism that controls pelletizing of the ceramic raw material by directing the ceramic raw material through the holes of the rotating first unit and the rotating second unit (1,2). When detected that a slower movement of the ceramic raw material flows through the holes (11) of the first rotating unit and the second rotating unit (2,3) occurs, the movable housing (51) should be actuated to move the second rotating unit (3) further away from the first rotating unit (2) through the actuator coupled relative to the frame, in order to create more space movement between the first and second rotating units (2,3).

In another embodiment, the powering mechanism may include a plurality of elements including a connecting body, a connecting rod, a plurality of gear parts, a pluggable member, a linking member, and a coupling member. The connecting rod may connect with the connecting body through a longitudinal twist spliced connection, and connects with the gear parts through a transverse twist spliced connection. Further, a plurality of gullets, which correspond to the lateral teeth element, may be provided at the inner facing surface of the pluggable member. Further in the embodiment, gear parts can be inserted in the pluggable member and are capable of telescopic movement within the pluggable member. The linking member connects with the pluggable member through a first linking connection; and the linking member connects with the coupling member through a second linking connection.

In an embodiment of the disclosed technology, a device is used for effectively pelletizing ceramic raw material. The device may employ one or more of the following components: a) a frame (1); b) a movable housing (51) movably attached to the frame (1) through an actuator (9) coupled relative to the frame; c) a first rotating unit (2) rotatably coupled to a power source (6) through a rotatable body (4), wherein a plurality of holes (11) are disposed in the first rotating unit (2) and the first rotating unit (2) is attached to the frame (1); d) a second rotating unit (2) rotatably coupled to a power housing structure (8) through a powering mechanism (7), wherein: i) the second rotating unit (3) includes a plurality of holes (11); ii) the second rotating unit (3) is attached to the frame (1) through the movable housing (51); and/or iii) the second rotating unit (3) is separated from the first rotating unit (2) relative to the frame (1); e) an object with an opening located on top of the first rotating unit and the second rotating unit (1,2), wherein the opening allows the ceramic raw material to be received into the first rotating unit and the second rotating unit (1,2); and/or f) a logical processor having a detection mechanism that controls pelletizing of the ceramic raw material by directing the ceramic raw material through the holes of the rotating first unit and the rotating second unit (1,2).

Detection that the ceramic raw material flows through the holes (11) of the first rotating unit and the second rotating unit (2,3) at a slower movement causes actuation of the movable housing (51) to move the second rotating unit (3) further away from the first rotating unit (2) through the actuator coupled relative to the frame. The ceramic raw material flows through the holes (11) of the first rotating unit and the second rotating unit (2,3).

In a further embodiment, the powering mechanism may also have one or more of the following components: a connecting body (71), a connecting rod (72), a plurality of gear parts (73), a pluggable member (74), a linking member (75), a coupling member (76), a lateral teeth element (77); a plurality of gullets provided at the inner facing surface of the pluggable member (74), and/or a rotating body (81) attached to the connecting body (71). The connecting rod (72) may connect with the connecting body (71) through a longitudinal twist spliced connection, and connects with the gear parts (73) through a transverse twist spliced connection. The gullets may correspond to the lateral teeth element (77). The gear parts (73) may be inserted into the pluggable member (74) and are capable of telescopic movement within the pluggable member (74). The linking member (75) may connect with the pluggable member (74) through a first linking connection. The linking member (75) also connects with the coupling member (76) through a second linking connection.

Still further, the first rotating unit and the second rotating unit (1,2) may be opposite to each other. The rotatable body (4) may be a first roller shaft. The powering mechanism (7) may include a second roller shaft (5), wherein the first rotating unit is pivotally disposed on the first roller shaft, and the second rotating unit is pivotally disposed on the second roller shaft. The first and second rotating units (2,3) may be erected on the frame (1) through the first and second roller shafts (4,5) on the bearing housing (51) of the frame (1). The roller shaft (4) of the first rotating unit (2) may be in direct contact with the power source (6), wherein positioning the roller shaft of the right rotating unit in direct contact with a power harness (8), wherein connecting the coupling member (76) of the powering mechanism (7) with the second roller shaft (5) on the second rotating unit (3) through a fixed position.

The movable housing (51) may be a bearing housing. The actuator (9) may be a spring fitted on the frame (1), wherein the spring presses against the bearing housing (51) of the right rotating unit, in order to apply pressure on the bearing housing (51) while allowing lateral movement of the bearing housing (51) along the axis of the spring (9).

Still further, an outer wall may be included on each side of the first and second rotating units (2, 3), and the plurality of holes (11) are provided on the outer wall of the first and second rotating units (2, 3). Also, the pluggable member (74) may be a sleeve member (74). The rotating body (81) may be a spindle and may be attached to the power source (6) in a fixed position such that the connector (71) is pivotally disposed on the spindle. The powering mechanism may have a first linking connection being a longitudinal twist spliced connection and a second linking connection being a transverse twist spliced connection. The first and second rotating units may be rotating rollers (2,3).

### BRIEF DESCRIPTION OF THE DRAWINGS

FIG. 1 is an overview of the structure of the present inventive device.

FIG. 2a is a schematic diagram of the structure of FIG. 1.

FIG. 2b is an elevation view of the structure of FIG. 2a.

FIG. 3 is a magnified view of the composition of raw ceramic material used in accordance with one or more embodiments of the disclosed technology.

FIG. 4 is a high-level block diagram of a microprocessor device that may be used to carry out the disclosed technology.

### DETAILED DESCRIPTION

Referring now to the figures, methods and apparatuses are used for pelletizing ceramic material. In one embodiment, a device is provided that includes a frame, a movable housing, a first rotating unit, and a second rotating unit. The moving housing is configured so that when detected that a slower movement of the ceramic raw material flows through holes of the first rotating unit and the second rotating unit occurs, the movable housing is actuated to move the second rotating unit further away from the first rotating unit through the actuator coupled relative to the frame, in order to create more space movement between the first and second rotating units.

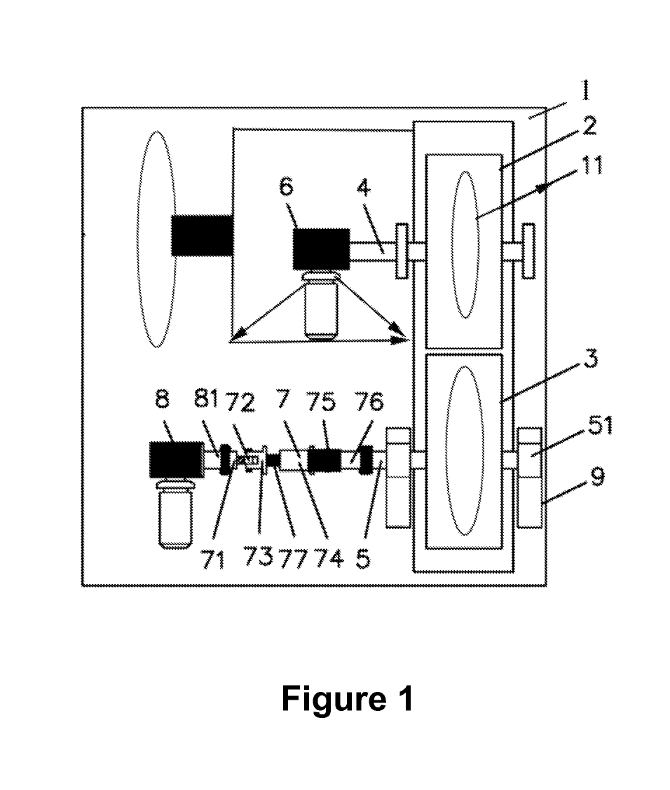

Referring now to FIG. 1, an overview of the structure of the present inventive device is depicted. A device is shown including a frame (1), a movable housing (51), a first rotating unit (2), a second rotating unit (3), an object with an opening located on top of the first rotating unit and the second rotating unit, and a logical processor. The movable housing is movably attached to the frame (1) through an actuator (9) coupled relative to the frame.

Two or more rotating units may be attached to the frame. In one embodiment, a first rotating unit may be rotatably coupled to a power source (6) through a rotatable body (4). The second rotating unit (3) may be rotatably coupled to a power housing structure (8) through a similar powering mechanism (7). In both rotating units, holes (11) are included in the rotating unit. The second rotating unit (3). The second rotating unit (3) is separated from the first rotating unit (2) relative to the frame (1). The embodied device may contain an object that has at least one opening located on top of the first rotating unit and the second rotating unit, allowing the ceramic raw material to be received into the first rotating unit and the second rotating unit.

Referring still to FIG. 1, the powering mechanism (7) may employ: a connecting body (71) with a rotating body (81) connected thereto, a connecting rod (72), a plurality of gear parts (73), a pluggable member (74), a linking member (75), a coupling member (76), and/or a lateral teeth element (77).

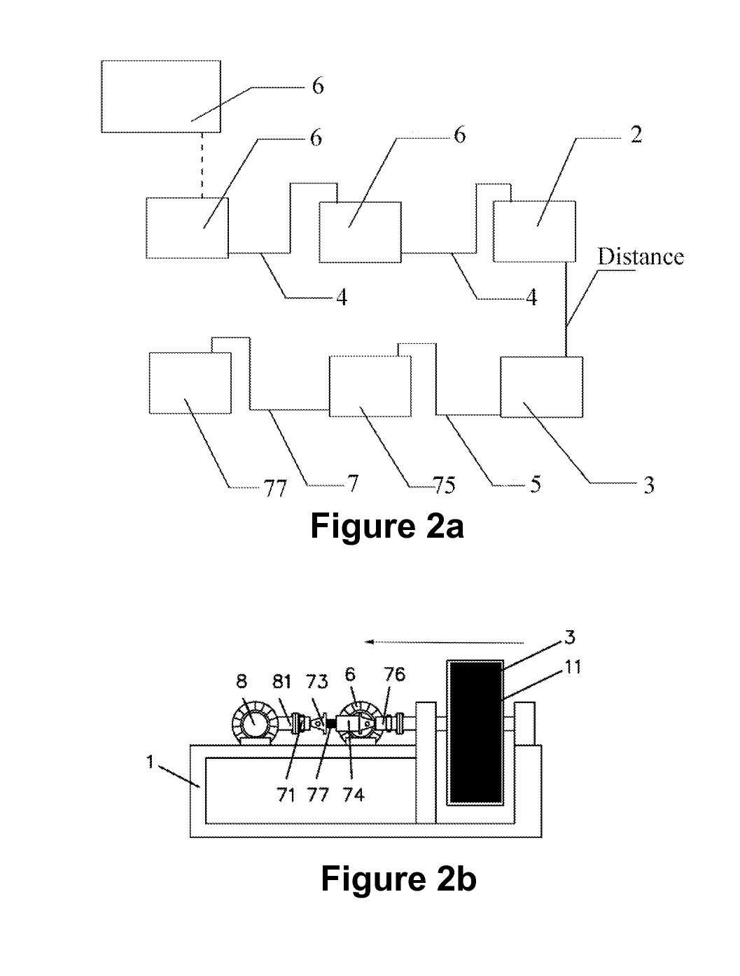

FIG. 2a is a schematic diagram of the structure of FIG. 1. FIG. 2b is an elevation view of the structure of FIG. 2a. The components described with respect to FIG. 1 are depicted in FIGS. 2a and 2b.

The logical processor includes a detection mechanism that controls pelletizing of the ceramic raw material by directing the ceramic raw material through the holes of the rotating first unit and the rotating second unit (1,2). When detected that a slower movement of the ceramic raw material flows through the holes (11) of the first rotating unit and the second rotating unit (2,3) occurs, the movable housing (51) should be actuated to move the second rotating unit (3) further away from the first rotating unit (2) through the actuator coupled relative to the frame, in order to create more space movement between the first and second rotating units (2,3).

In another embodiment, the powering mechanism may include a plurality of elements including a connecting body, a connecting rod, a plurality of gear parts, a pluggable member, a linking member, and a coupling member. The connecting rod may connects with the connecting body through a longitudinal twist spliced connection, and connects with the gear parts through a transverse twist spliced connection. Further, a plurality of gullets, which correspond to the lateral teeth element, may be provided at the inner facing surface of the pluggable member. Further in the embodiment, gear parts can be inserted in the pluggable member and are capable of telescopic movement within the pluggable member. The linking member connects with the pluggable member through a first linking connection; and the linking member connects with the coupling member through a second linking connection.

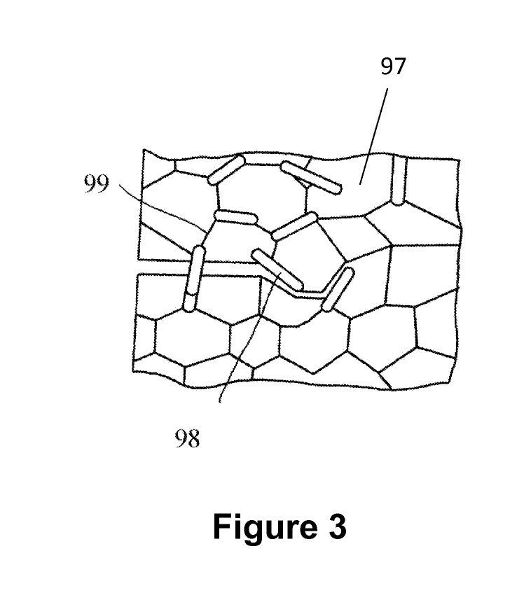

FIG. 3 is a magnified view of the composition of raw ceramic material used in accordance with one or more embodiments of the disclosed technology. Different sized ceramic pellets 97 are arranged in a composite grid. The gaps 99 between the pellets are also depicted in FIG. 3. Additionally, voids or gaps 98 are shown propagating through the composite.

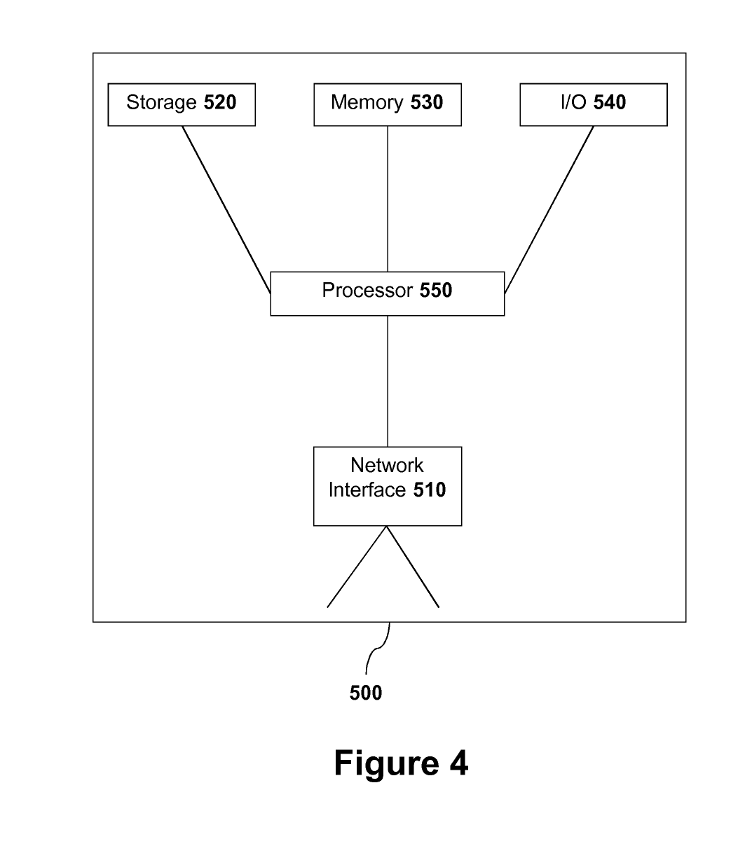

FIG. 4 is a high-level block diagram of a microprocessor device that may be used to carry out the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

One skilled in the art will recognize that an implementation of an actual device will contain other components as well, and that FIG. 3 is a high level representation of some of the components of such a device for illustrative purposes. It should also be understood by one skilled in the art that the method and devices depicted in FIGS. 1, 2a, 2b, and 3 may be implemented on a device such as is shown in FIG. 4.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed:

1. A device for effectively pelletizing ceramic raw material, comprising:
a frame (1);
a movable housing (51) movably attached to the frame (1) through an actuator (9) coupled relative to the frame;
a first rotating unit (2) rotatably coupled to a power source (6) through a rotatable body (4), wherein:
a plurality of holes (11) are disposed in the first rotating unit (2); and
the first rotating unit (2) is attached to the frame (1);
a second rotating unit (2) rotatably coupled to a power housing structure (8) through a powering mechanism (7), wherein:
the second rotating unit (3) includes a plurality of holes (11);
the second rotating unit (3) is attached to the frame (1) through the movable housing (51); and
the second rotating unit (3) is separated from the first rotating unit (2) relative to the frame (1);
an object with an opening located on top of the first rotating unit and the second rotating unit (1,2), wherein the opening allows the ceramic raw material to be received into the first rotating unit and the second rotating unit (1,2); and
a logical processor having a detection mechanism that controls pelletizing of the ceramic raw material by directing the ceramic raw material through the holes of the rotating first unit and the rotating second unit (1,2), wherein detection that the ceramic raw material flows through the holes (11) of the first rotating unit and the second rotating unit (2,3) at a slower movement causes actuation of the movable housing (51) to move the second rotating unit (3) further away from the first rotating unit (2) through the actuator coupled relative to the frame.

2. The device of claim 1, wherein the powering mechanism (7) further comprises:
a connecting body (71),
a connecting rod (72),
a plurality of gear parts (73),
a pluggable member (74),
a linking member (75),
a coupling member (76), wherein:
a rotating body (81) is attached to the connecting body (71); and
the connecting rod (72) connects with the connecting body (71) through a longitudinal twist spliced connection, and connects with the gear parts (73) through a transverse twist spliced connection;
a lateral teeth element (77); and
a plurality of gullets provided at the inner facing surface of the pluggable member (74), wherein:
the gullets correspond to the lateral teeth element (77);
the gear parts (73) are inserted in the pluggable member (74) and are capable of telescopic movement within the pluggable member (74);
the linking member (75) connects with the pluggable member (74) through a first linking connection; and
the linking member (75) connects with the coupling member (76) through a second linking connection.

3. The device of claim 1, wherein the first rotating unit and the second rotating unit (1,2) are opposite to each other.

4. The device of claim 1, wherein the rotatable body (4) is a first roller shaft.

5. The device of claim 4, wherein:
The powering mechanism (7) includes a second roller shaft (5), wherein the first rotating unit is pivotally disposed on the first roller shaft, and the second rotating unit is pivotally disposed on the second roller shaft;
the first and second rotating units (2,3) are erected on the frame (1) through the first and second roller shafts (4,5) on the bearing housing (51) of the frame (1); and
the roller shaft (4) of the first rotating unit (2) in direct contact with the power source (6), wherein positioning the roller shaft of the right rotating unit in direct contact with a power harness (8), wherein connecting the coupling member (76) of the powering mechanism (7) with the second roller shaft (5) on the second rotating unit (3) through a fixed position.

6. The device of claim 2, wherein the movable housing (51) is a bearing housing.

7. The device of claim 6, wherein the actuator (9) is a spring fitted on the frame (1), wherein the spring presses against the bearing housing (51) of the right rotating unit, in order to apply pressure on the bearing housing (51) while allowing lateral movement of the bearing housing (51) along the axis of the spring (9).

8. The device of claim 7, wherein an outer wall is included on each side of the first and second rotating units (2, 3), and the plurality of holes (11) are provided on the outer wall of the first and second rotating units (2, 3).

9. The device of claim 8, wherein the pluggable member (74) is a sleeve member (74).

10. The device of claim 9, wherein the rotating body (81) is a spindle and is attached to the power source (6) in a fixed position such that the connector (71) is pivotally disposed on the spindle.

11. The device of claim 10, wherein the powering mechanism has a first linking connection being a longitudinal twist spliced connection and a second linking connection being a transverse twist spliced connection.

12. The device of claim 1, wherein the first and second rotating units are rotating rollers (2,3).
